(19) United States
(12) Patent Application Publication
(10) Pub. No.: US 2012/0002094 A1
(43) Pub. Date: Jan. 5, 2012

(54) IMAGE PICKUP APPARATUS FOR PROVIDING REFERENCE IMAGE AND METHOD FOR PROVIDING REFERENCE IMAGE THEREOF

(75) Inventor: Michal JELICZ, Warsaw (PL)

(73) Assignee: SAMSUNG ELECTRONICS CO., LTD., Suwon-si (KR)

(21) Appl. No.: 13/174,897

(22) Filed: Jul. 1, 2011

(30) Foreign Application Priority Data
Jul. 1, 2010 (KR) 10-2010-0063541

(51) Int. Cl. H04N 5/225

(52) U.S. Cl. 348/333.11; 348/E05.024

(57) ABSTRACT

A image pickup apparatus and a method for providing a reference image thereof are provided. The image pickup apparatus includes: an image pickup unit; a storage unit which stores image data captured by the image pickup unit is stored; an image processing unit which generates a preview image of a subject currently captured by the image pickup unit; a controlling unit which selects a reference image from the previously stored image data in the storage unit; and a display which displays the selected reference image together with the preview image. Thus, as the preview image is displayed together with the reference image when taking a photograph, a user is able to compare the preview image with the previously photographed image and take the photograph accordingly.

### CROSS-REFERENCE TO RELATED APPLICATION

This application claims priority from Korean Patent Application No. 10-2010-0063541, filed on Jul. 1, 2010 in the Korean Intellectual Property Office, the disclosure of which is incorporated herein by reference in its entirety.

### BACKGROUND

1. Field

Apparatuses and methods consistent with exemplary embodiments relate to an image pickup apparatus for providing a reference image and a method thereof, and more particularly, to an image pickup apparatus having a display capable of providing a preview image together with a reference image and a method thereof.

2. Description of the Related Art
With the development of image processing and photographing technologies, image pickup apparatuses are providing users with various operations and modes. For example, providing various operations such as auto focusing, auto exposure, and auto white balancing, image pickup apparatuses are capable of taking high-resolution pictures. In addition, providing various modes such as black-and-white mode, indoor mode, and blurry mode, image pickup apparatuses enable users to take pictures that they want in a desired environment.

However, despite the various operations and modes that an image pickup apparatus provides, in a case where a user intends to take another picture against the same backdrop or direction as a previous picture, or where a user intends to take pictures of changes of a plant or a landscape, the user must go through the inconvenience of searching the images that had been previously taken and stored one by one, opening the searched image, and compare the searched image with the image to be taken.

Moreover, even if the user successfully opens the searched image, since the user cannot compare the searched image with the image to be photographed, the direction and background of the previously photographed picture and those of the picture to be taken may not exactly match, such that the user is unable to take a desired picture.

### SUMMARY

Exemplary embodiments overcome the above disadvantages and other disadvantages not described above. However, it is understood that an exemplary embodiment is not required to overcome the disadvantages described above, and an exemplary embodiment may not overcome any of the problems described above. One or more exemplary embodiments provide an image pickup apparatus for providing a reference image and a method thereof.

According to an aspect of an exemplary embodiment, there is provided an image pickup apparatus including: an image pickup unit which captures an image; a storage unit which stores image data photographed by the image pickup unit; an image processing unit which generates a preview image of a subject currently captured by the image pickup apparatus; a controlling unit which selects a reference image from the image data previously stored in the storage unit; and a display which displays the selected reference image together with the preview image.

The display may display the preview image to overlap with the reference image that is a base image.

The display may display only an outline of at least one of the reference image and the preview image.
The display may display a screen having a first area which displays the overlapping of the reference image and the preview image and a second area which displays a zoomed in image of a portion of the first area.
The image pickup apparatus may further include a user operation unit which receives a user input, wherein the controlling unit may select, as the reference image, image data selected according to the user input.

The controlling unit may select, as the reference image, image data most recently stored from among the image data stored in the storage unit.

The controlling unit may select, as the reference image, image data determined to be relevant to the preview image from among the image data stored in the storage unit.

According to an aspect of an exemplary embodiment, there is provided a method of providing a reference image, the method including: generating a preview image of a subject currently captured by an image pickup unit; selecting a reference image from previously stored image data; and displaying the selected reference image together with the preview image.

The displaying may include displaying the preview image to overlap with the reference image that is a base image.

The displaying may include displaying only an outline of at least one of the reference image and the preview image.

The displaying may include displaying a first area which displays the overlapping of the reference image and the preview image and a second area which displays a zoomed in image of a portion of the first area.

The selecting may include: receiving a user input; and selecting, as the reference image, image data selected according to the user input.

The selecting may include selecting, as the reference image, image data determined to be relevant to the preview image from among the previously stored image data.

According to an aspect of another exemplary embodiment, there is provided a method of providing a reference image, the method including: generating a preview image of a subject currently captured by an image pickup unit; and displaying a reference image, which is previously stored image data photographed by the image pickup unit, together with the preview image.

### BRIEF DESCRIPTION OF THE DRAWINGS

The above and/or other aspects will become more apparent by describing in detail exemplary embodiments with reference to the attached drawings in which:

FIG. 1 is a block diagram of an image pickup apparatus according to an exemplary embodiment;

FIGS. 2A to 2D are figures illustrating a reference image mode of an image pickup apparatus according to an exemplary embodiment; and

FIG. 3 is a flowchart illustrating a reference screen mode of an image pickup apparatus according to an exemplary embodiment.

### DETAILED DESCRIPTION OF EXEMPLARY EMBODIMENTS

Exemplary embodiments will now be described with reference to the accompanying drawings. It is understood that expressions such as “at least one of,” when preceding a list of elements, modify the entire list of elements and do not modify the individual elements of the list.

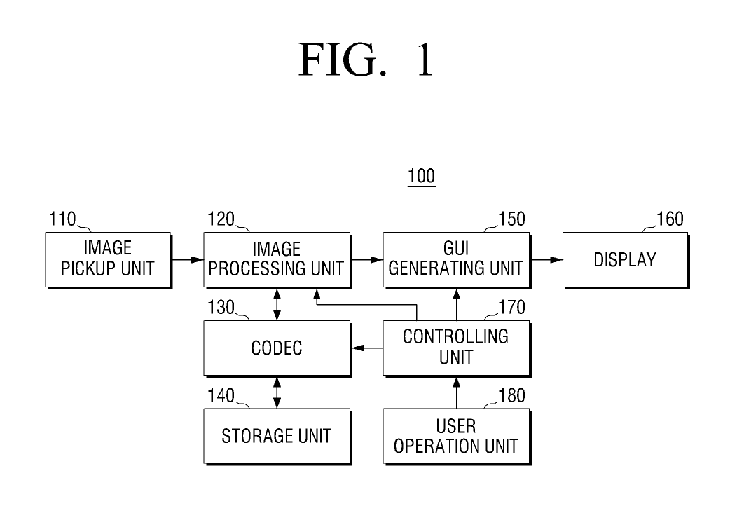

FIG. 1 is a block diagram of an image pickup apparatus 100 according to an exemplary embodiment. The image pickup apparatus 100 illustrated in FIG. 1 may be a digital camera, a digital camcorder, etc. Referring to FIG. 1, the image pickup apparatus 100 includes an image pickup unit 110, an image processing unit 120, a codec 130, a storage unit 140, a graphical user interface (GUI) generating unit 150, a display unit 160, a controlling unit 170, and a user operating unit 180.

The image pickup unit 110 includes a lens (not illustrated) and an image sensor (not illustrated), and photographs a subject. Specifically, the image pickup unit converts an image of a subject through the lens and imaged on an optical surface of an image pickup element into an image signal.

The image processing unit 120 performs an image signal processing on the image signal generated by the image pickup unit 110. Furthermore, the image processing unit 120 processes the image signal so that a reference image selected by a user and a preview image photographed by the image pickup unit 110 are displayed together. Hereinafter, the reference image is an image that is displayed at the same time as the preview image so that the reference image can be compared to the preview image,

The codec 130 compresses the image signal processed by the image processing unit 120 and generates an image file. The storage unit 140 stores the image file generated by the CODEC 130. For example, the storage unit 140 may be external or internal, and may be a volatile memory (such as RAM) or a nonvolatile memory (such as ROM, flash memory, a hard disk drive, etc.).

The storage unit 140 reads the stored image file and transmits the read image file to the codec 130. The codec 130 decompresses the transmitted image file, generates an image signal, and transmits the generated image signal to the image processing unit 120.

The GUI generating unit 150 generates a GUI, and adds the generated GUI to the image processed by the image processing unit 120. For example, in the case of a reference image mode, the GUI generating unit 150 generates a GUI indicating the reference image mode, and adds the GUI to the image processed by the image processing unit 120. The GUI generating operation of the GUI generating unit 150 is controlled by the controlling unit 170, as will be described below.

The display 160 displays the image to which the GUI has been added by the GUI generating unit 150. The image displayed on the display 160 is the preview image photographed by the image pickup unit 110 or an image read from the storage unit 140. In the present disclosure, the preview image refers to the image obtained through the image pickup unit 110 and displayed on the display 160 prior to photographing the image.

Moreover, the display 160 may display a reference image selected through the user operation unit 170 together with the preview image. In particular, with the selected reference image as a base image, the display 160 may display the preview image so that the preview image overlaps with the reference image. In this exemplary case, the display 160 fixedly displays the selected reference image. Accordingly, when the image pickup unit 110 moves, thus changing the preview image, the display 160 may display the changed preview image over the fixed reference image.

In particular, the display 160 may display either of the reference image or the preview image vaguely, so that the reference image and the preview image are distinguishable from each other. For example, the reference image may be displayed clearly together with the preview image that is displayed more vaguely than the reference image. In the same manner, the preview image may be displayed clearly together with the reference image that is displayed more vaguely than the preview image. Which of the reference image and the preview image that is to be displayed vaguely may be set by a manufacturer or selected through the user operation unit 180.

Furthermore, the display 160 may display only the outline of the reference image or the preview image. For example, the reference image may be displayed in the original state together with the outline of the preview image, or the preview image may be displayed in the original state together with the outline of the reference image.

As described above, the display 160 may distinctly display the reference image and the preview image by displaying the preview image or the reference image vaguely or displaying only the outline of the preview image or the reference image. However, it is understood that another exemplary embodiment is not limited thereto. That is, according to another exemplary embodiment, the display 160 may additionally or alternatively display the preview image and the reference image together in any manner so as to distinguish the two images from each other.

The user operation unit 180 transmits a user input signal according to a user's input command to the controlling unit 170. For example, a user may select a reference image through the user operation unit 180. Moreover, the user operation unit 180 may be embodied as at least one of a touch screen, a button, a rotatable dial, a keyboard, etc.

The controlling unit 170 controls the overall operations of the image pickup apparatus 100 according to the user input signal.

Moreover, the controlling unit 170 controls the image processing unit 130 to perform additional operations, such as auto focusing, auto exposure, auto white balancing, etc.

Furthermore, the controlling unit 170 may select a reference image from the image data stored in the storage unit 140. For example, the controlling unit 170 may select as the reference image the image data selected by the user input signal input. Also, the controlling unit 170 may select, as the reference image, image data that has been stored most recently from among image data stored in the storage unit 140. Moreover, the controlling unit 170 may select as the reference image an image relevant to a preview image from among the image data stored in the storage unit 140. The image relevant to the preview image may, for example, be an image of which location information (such as global positioning system (GPS) coordinates) or pixel information is relevant to that of the preview image.

In the case of selecting a relevant image using the location information, by using the location information of the currently provided preview image, the controlling unit 170 searches for image data having location information that is similar to that of the preview image from the stored image data. The controlling unit 170 may provide as the reference image the image data having the location information that is most similar to that of the currently provided preview image, or may provide for selection a plurality of reference images having location information that is most similar to that of the currently provided preview image.

In the case of selecting a relevant image using the pixel information, by using the pixel information of the currently provided preview image, the controlling unit 170 searches for image data having pixel information that is similar to that of the preview image from the stored image data. The controlling unit 170 may provide as the reference image the image data having the pixel information that is most similar to that of the currently provided preview image, or may provide for selection a plurality of reference images having pixel information that is most similar to that of the currently provided preview image. The pixel information may be pixel information of the entirety of an image or pixel information of a specific area.

As described above, by displaying the preview image together with the reference image, the apparatus enables the user to take a picture while comparing the preview image with the previously photographed image.

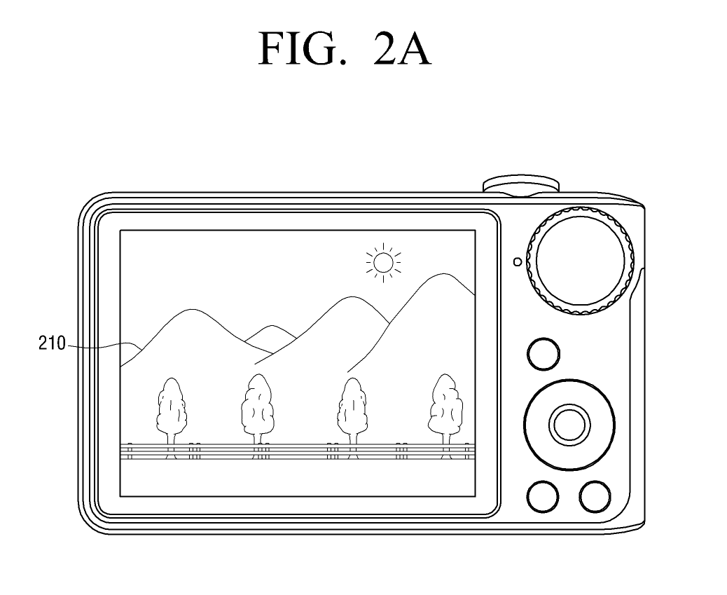

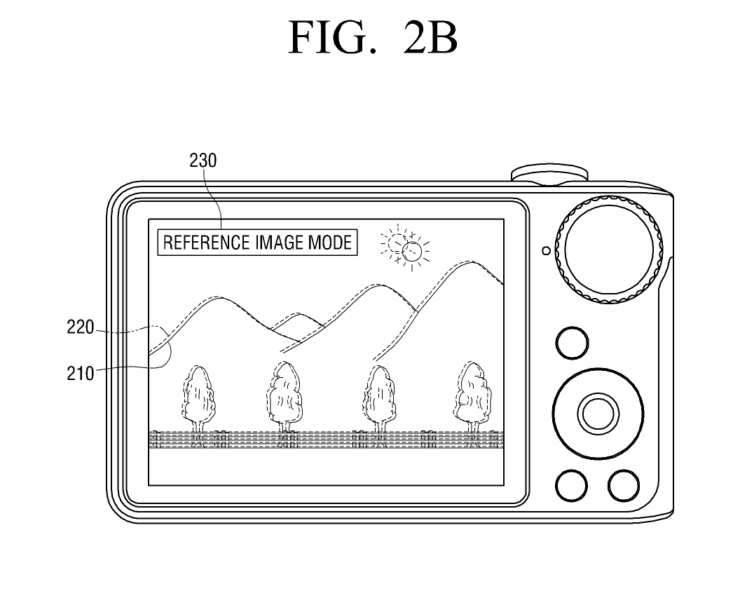

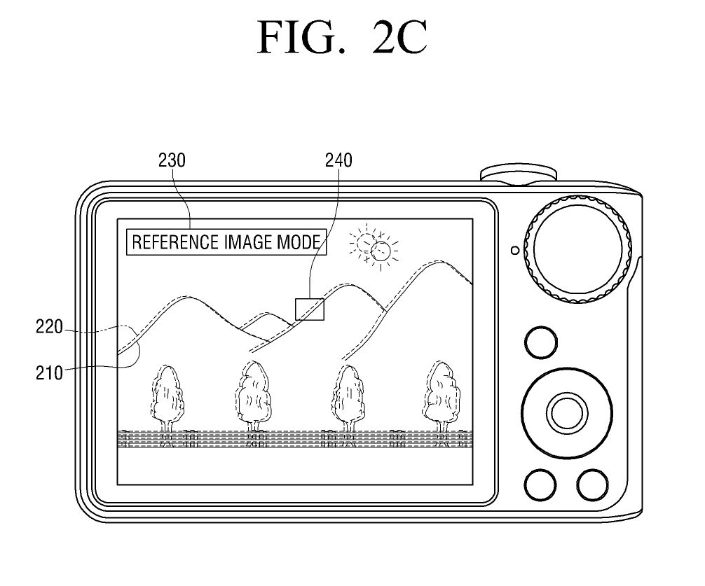

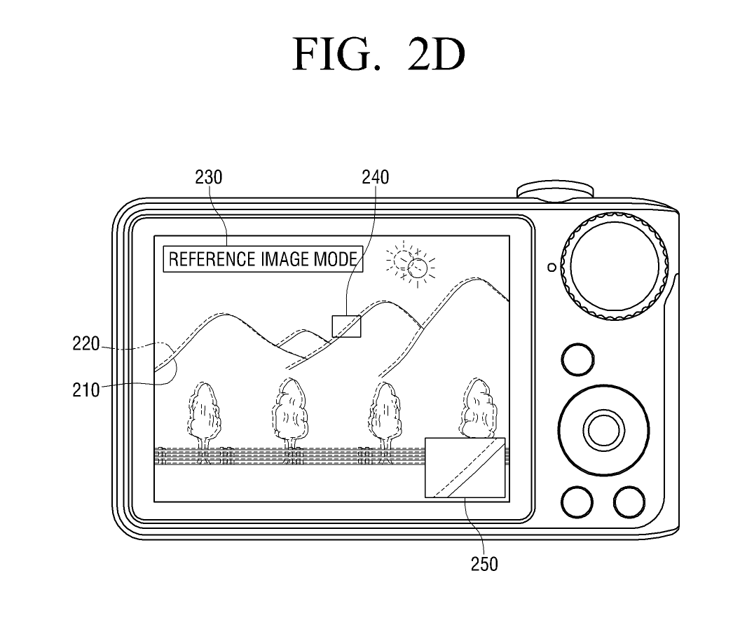

Hereinafter, a reference image mode of an image pickup apparatus 100 according to an exemplary embodiment will be explained in detail with reference to FIGS. 2A to 2D.

FIG. 2A illustrates a screen displayed on a display 160 of an image pickup apparatus 100 according to an exemplary embodiment. Referring to FIG. 2A, the screen displayed on the display 160 is a preview image 210. In the state where the preview image 210 is displayed, when the reference image mode is selected through the user operation unit 180, the image pickup apparatus 100 provides the reference image mode. It is understood that, not only may the displaying of the preview image 210 be set by the user, but the providing of the reference image mode may be set by the user even before the preview image is displayed.

FIG. 2B illustrates a screen displayed on the display 160 of the image pickup apparatus 100 when the reference image mode is selected.

Referring to FIG. 2B, when the reference image mode is selected, the reference image 220 selected by the user is displayed on the image pickup apparatus 100 together with the preview image 210. The user may select an image to be the reference image 220 from the image data stored in the storage unit 140 through the user operation unit 180. Alternatively, the image pickup apparatus 100 may select, as the reference image, image data stored most recently or image data relevant to the preview image from among the image data stored in the storage unit 140.

As illustrated in FIG. 2B, with the selected reference image 220 as the base image, the display 160 may display the preview image 210 to overlap with the reference image 220. Specifically, the reference image 220 is fixed and displayed even as the image pickup apparatus 100 moves. Meanwhile, as for the preview image 210, the changed subject is displayed over the fixated reference image 220 as the image pickup apparatus 100 moves. Therefore, by moving the image pickup unit apparatus 100, the user is able to overlap the preview image 210 with the fixated reference image 220.

Furthermore, the reference image 220 may be displayed together with the preview image 210 in a more vague state than the preview image 210. However, it is understood that another exemplary embodiment is not limited thereto, and the preview image 210 and the reference image 220 may be distinguished from each other in any way according to another exemplary embodiment. For example, the preview image 210 may be displayed together with the reference image 220 in a more vague state than the reference image 220. As another example, the display 160 may display only the outline of either one of the preview image 210 and the reference image 220.

Furthermore, as illustrated in FIG. 2B, when the reference image mode is selected, a GUI 230 that indicates that the current mode is the reference image mode may be generated and displayed together with the reference image and the preview image.

FIGS. 2C and 2D illustrate a screen displayed on the display 160 of the image pickup apparatus 100 when a digital zoom in is performed on a specific area.

Referring to FIGS. 2C and 2D, in a state where the preview image 210 and the reference image 220 are displayed together, the image pickup apparatus 100 may perform the digital zoom as an operation through the user operation unit 180. Accordingly, a first area 240 on the screen where the preview image 210 and the reference image 220 are displayed together may be zoomed in on to check whether the preview image 210 and the reference image 220 overlap with each other exactly.

In this exemplary case, the first area 240 is the subject area where the user wishes to check the precision of the overlapping. The first area 240 may be moved through the user operation unit 180.

When the user performs a digital zoom on the first area 240 through the user operation unit 180, the zoomed in first area 240 may be displayed on a second area 250 of the screen where the preview image 210 and the reference image 220 is displayed together.

Therefore, the user is able to check whether the preview image 210 and the reference image 220 overlap with each other exactly using the digital zoom in operation.

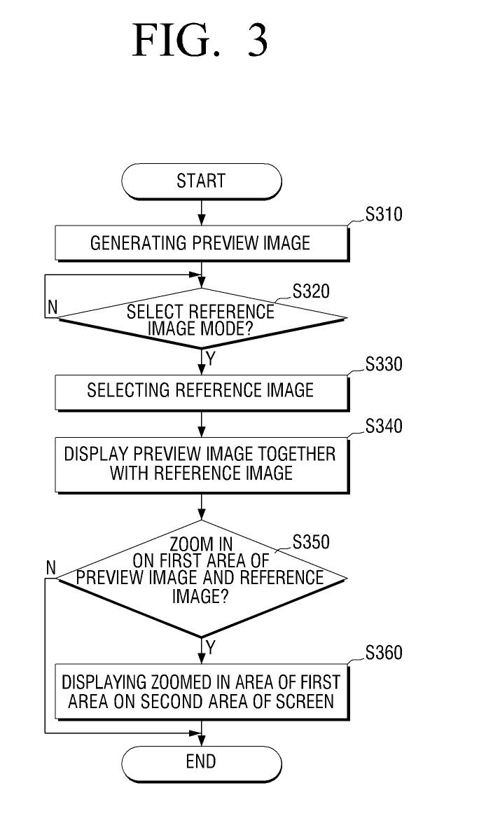

Hereinafter, a method of providing a reference image to an image pickup apparatus 100 according to an exemplary embodiment is explained with reference to FIG. 3.

FIG. 3 is a flowchart illustrating a reference screen mode of an image pickup apparatus 100 according to an exemplary embodiment.

Referring to FIG. 3, the image pickup apparatus 100 generates an image captured through an image pickup unit 110 as a preview image in operation S310. Moreover, the image pickup apparatus 100 determines whether a reference image mode has been selected through the user operation unit 180 in operation S320.

If the reference image mode has been selected (operation S320-Y), the image pickup apparatus 100 selects a reference image in operation S330. Specifically, the image pickup apparatus 100 may select, as the reference image, image data selected by a user input through a user operation unit 180. Moreover, the image pickup apparatus 100 may select as the reference image the most recently stored image data from the storage unit 140. Furthermore, the image pickup apparatus 100 may select, as the reference image, image data relevant to the preview image from among the image data stored in the storage unit 140. Herein, the relevant image data may be image data having location information or pixel information that is relevant to that of the preview image.

When the reference image is selected according to the aforementioned method, the image pickup apparatus 100 displays the preview image together with the reference image in operation S340. Specifically, the image pickup apparatus 100 may display the preview image to overlap with the reference image, with the selected reference image as the base image. In this case, the image pickup apparatus 100 fixedly displays the selected reference image. Meanwhile, if the image pickup apparatus 100 moves, thus changing the preview image, the display 160 may display the changed preview image over the fixed reference image.

In particular, the image pickup apparatus 100 may display at least one of the reference image and the preview image vaguely so that the reference image and the preview image are distinguishable from each other. For example, the preview image may be displayed clearly together with the reference image that is displayed more vaguely than the preview image. Which of the reference image and the preview image is to be displayed vaguely may be set by a manufacturer or through the user operation unit 180.

Furthermore, the image pickup apparatus 100 may display only the outline of at least one of the reference image and the preview image. For example, the reference image may be displayed in the original state together with the outline of the preview image, or the preview image may be displayed in the original state together with the outline of the reference image. It is understood that any method of distinctly displaying the reference image and the preview image may be implemented in another exemplary embodiment.

After the preview image is displayed together with the reference image, the image pickup apparatus 100 checks whether to perform a digital zoom operation on a first area of the preview image and the reference image in operation S350. The first area may be a subject area where the user wishes to check whether the overlapping has been precisely made. The first area may be moved through the user operation unit 180.

When the command to perform the digital zoom operation on the first area is input through the user operation unit 180 (operation 8350-Y), the image pickup apparatus 100 displays the zoomed in image of the first area on a second area of the screen where the preview image and the reference image are displayed in operation S360.

As described above, according to one or more exemplary embodiments, by displaying the preview image together with the reference image when taking a picture, the image pickup apparatus 100 enables the user to compare the image to the previously photographed picture when taking a picture.

While not restricted thereto, an exemplary embodiment can also be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an exemplary embodiment may be written as computer programs transmitted over a computer-readable transmission medium, such as a carrier wave, and received and implemented in general-use or special-purpose digital computers that execute the programs. Moreover, while not required in all exemplary embodiments, one or more units of the image pickup apparatus 100 can include a processor or microprocessor executing a computer program stored in a computer-readable medium.

Although exemplary embodiments have been shown and described, it would be appreciated by those skilled in the art that changes may be made in the exemplary embodiment without departing from the principles and spirit of the inventive concept, the scope of which is defined in the claims and their equivalents.

What is claimed is:

1. An image pickup apparatus comprising:
an image pickup unit which captures an image;
a storage unit which stores image data captured by the image pickup unit;
an image processing unit which generates a preview image of a subject currently captured by the image pickup unit;
a controlling unit which selects a reference image from the image data previously stored in the storage unit; and
a display which displays the selected reference image together with the preview image.

2. The image pickup apparatus according to claim 1, wherein the display displays the preview image to overlap with the reference image that is a base image.

3. The image pickup apparatus according to claim 2, wherein the display displays only an outline of at least one of the reference image and preview image.

4. The image pickup apparatus according to claim 2, wherein the display displays one of the reference image and the preview image more vaguely than another of the reference image and the preview image.

5. The image pickup apparatus according to claim 2, wherein the display displays the reference image and the preview image to distinguish from each other.

6. The image pickup apparatus according to claim 2, wherein the display displays a first area that displays the overlapping of the reference image and the preview image and a second area that displays a zoomed in image of a portion of the first area.

7. The image pickup apparatus according to claim 1, further comprising:
a user operation unit which receives a user input,
wherein the controlling unit selects, as the reference image, image data selected according to the user input.

8. The image pickup apparatus according to claim 1, wherein the controlling unit selects, as the reference image, image data most recently stored from among the image data stored in the storage unit.

9. The image pickup apparatus according to claim 1, wherein the controlling unit selects, as the reference image, image data determined to be relevant to the preview image from among the image data stored in the storage unit.

10. The image pickup apparatus according to claim 9, wherein the controlling unit selects, as the reference image, image data determined to have location information most similar to location information of the preview image from among the stored image data.

11. The image pickup apparatus according to claim 9, wherein the controlling unit selects, as the reference image, image data determined to have pixel information most similar to pixel information of the preview image from among the stored image data.

12. A method of providing a reference image, the method comprising:
generating a preview image of a subject currently captured by an image pickup unit;
selecting a reference image from among previously stored image data captured by the image pickup unit; and
displaying the selected reference image together with the preview image.

13. The method according to claim 12, wherein the displaying comprises displaying the preview image to overlap with the reference image that is a base image.

14. The method according to claim 13, wherein the displaying the preview image to overlap with the reference image comprises displaying only an outline of at least one of the reference image and the preview image.

15. The method according to claim 13, wherein the displaying the preview image to overlap with the reference image comprises displaying a first area that displays the overlapping of the reference image and the preview image and a second area that displays a zoomed in image of a portion of the first area.

16. The method according to claim 12, wherein the selecting comprises:
receiving a user input; and
selecting, as the reference image, image data selected according to the user input.

17. The method according to claim 12, wherein the selecting comprises selecting, as the reference image, image data most recently stored from among the previously stored image data.

18. The method according to claim 12, wherein the selecting comprises selecting, as the reference image, image data determined to be relevant to the preview image from among the previously stored image data.

19. A method of providing a reference image, the method comprising:
generating a preview image of a subject currently captured by an image pickup unit; and
displaying a reference image, which is previously stored image data captured by the image pickup unit, together with the preview image.

20. A computer readable recording medium having recorded thereon a program executable by a computer for performing the method of claim 12.
